(19) United States
(12) Patent Application Publication
(10) Pub. No.: US 2015/0100421 A1
(43) Pub. Date: Apr. 9, 2015

(54) Method and Apparatus for Facilitating Consumer Marketer Interaction

(71) Applicants: Mehrnoosh Dehaghani, Sheffield (GB); Chris Barratt, Sheffield (GB); Robert Cruickshank, Essex (GB)

(72) Inventors: Mehrnoosh Dehaghani, Sheffield (GB); Chris Barratt, Sheffield (GB); Robert Cruickshank, Essex (GB)

(21) Appl. No.: 14/048,370

(22) Filed: Oct. 8, 2013

(51) Int. Cl. G06Q 30/02

(52) U.S. Cl. CPC G06Q 30/0255
USPC 705/14.53

(57) ABSTRACT

The present invention allows marketers to provide consumers and potential consumers with interactive and quickly updateable content by providing the consumer with a dashboard engagement device such as a Web key or USB key. This object may be accomplished via an electronic device such as a personal computer. Other means to further this end include, but are not limited to, mobile electronic computing devices capable of loading platforms for marketers to communicate with consumers and potential consumers.

### CROSS-REFERENCE TO RELATED APPLICATIONS

None.

### BACKGROUND

The following is a tabulation of some prior art that presently appears relevant:

### U.S. Patents

| Pat. No. | Kind Code | Issue Date | Patentee |
|---|---|---|---|
| 6,691,155 | B2 | Feb. 10, 2004 | Gottfried |
| 7,0552,273 | B2 | Jun. 6, 2006 | Roshkoff |
| 8,296,229 | B1 | Oct. 23, 2012 | Yellin et al. |
| 8,321,792 | B1 | Nov. 27, 2012 | Alur et. al. |
| 8,396,742 | B1 | Mar. 12, 2013 | Blume et al. |
| 8,407,607 | B2 | Mar. 26, 2013 | Bragun et. al. |

### U.S. Patent Application Publications

| Publication Number | Kind Code | Publ. Date | Applicant |
|---|---|---|---|
| 2013/0070163 | A1 | Mar. 21, 2013 | Connors |
| 2013/0124301 | A1 | May 16, 2013 | Bachman |

### Foreign Patent Document

None found

### Nonpatent Literature Documents

None found

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### DISCUSSION OF THE RELATED ART

It is well know in the area of marketing to use incentive items to attract a consumer to a particular product or service. Using packing labels which include materials of value or interest to consumers as a means to this end are also known in the art. Such materials include coupons, mail-in rebates, sweepstakes entry forms, sample products or related product information. They are commonly delivered in large, inelegant multi-panel labels, expanded content labels or expanded content labels affixed to a product package.

In some instances, coupons that peel off of a package to be used at the time of purchase or another occasion have also been used. As with the other marketing means, these coupons are meant to entice consumers to make a purchase of the product in exchange for an incentive such as saving money on a particular item or service. Although effective as away to attract consumers, these tools do little to provide the advertiser with valuable consumer information for the purposes of marketing.

Information relating to the consumer is a highly valuable commodity particularly given the exorbitant cost associated with marketing today. Peeking consumer interest in a good or service is only accomplishing one of the marketers objectives but can be useful in accomplishing much more. Advertisers are constantly seeking information from consumers such their likes and dislikes, where they reside, and what attracted them to the advertisers product or service. This type of information can help the advertiser in many ways including enhancement of marketing techniques to yield optimized results from the amount of money they are expending on any given advertising campaign.

In the past, it has been known to cultivate this information through the use of surveys. These may be conduct over the Internet, through reply-back mailings, over the phone, or in person. In most instances, these methods of consumer data collection are time consuming, expensive, and, due to ineffective sampling pools, do not provide an accurate reflection of the entire market. Other problems that plague these data collection methods include dismal redemption rates, and distorted responses due to the fact that the survey taker is being motivated by incentives provided by the advertiser.

Accordingly, it has become very desirable, albeit challenging, for advertisers to obtain data from their customers in a manner that both elicits meaningful responses without necessarily enticing a purchase and is also adaptable to the myriad types of containers and products and services across countless industries. Nevertheless, in some instances, advertisers may also seek to combine enticing consumers to purchase a product with collecting consumer data information through surveys. In that case, it may be desirable for the incentive item to be visible on a product package.

There exists a need for a customer data collection system that is adaptable to the myriad types of containers and products and that allows delivery of an incentive device requiring a recipient to participate and submit personal data to redeem a given incentive. It is further desirous to do so in such a manner that both draws customer attention to the product or service being offered. There is even a further need for a combination incentive and data collection means that can be manufactured in a cost effective manner.

Various means for a marketer to communicate directly with consumers while learning about them have been proposed. However, none of the foregoing combine the characteristics of the present invention. Therefore, there is a need for a method and apparatus for facilitating consumer-marketer interaction which allows the marketer to provide current and instantly modifiable content. The present invention effectuates these needs.

### SUMMARY

The invention relates a method and apparatus for an advertiser to communicate directly with consumers while learning about them using a portable electronic device or web key. The device may be coupled directly to the advertisers product or affixed to promotional materials. This system encourages consumers to engage with advertisers by plugging in the electronic device into their home computers while accessing information, incentives, and promotions provided by the advertiser.

The promotion materials to which the electronic device or Web key may be affixed may comprise a variety of different embodiments. These include, but are not limited to, business cards, bottle tags that may fit around the neck of a beverage container, swing tags such as those commonly placed around door knobs or those worry around the neck such as with a press pass or Access All Areas (AAA) pass. In the Web key embodiment, a piece of marketing material may comprise a code which the consumer enters into an electronic device, such as a personal computer or mobile equivalent, to gain access to specific content provided by the marketer.

In another embodiment of the present invention, the electronic device will open a portal to the marketers uniquely designed dashboard once it is plugged into a computing device or other audio video display device comprising a video display. The means which the device may be plugged into the computer includes, but is not limited to, a universal serial bus (USB) port in which case the electronic dashboard engagement device would be a USB key.

The promotional materials comprising the electronic dashboard engagement device and/or Web key may further comprise a quick response (QR) code. This would allow marketers to instantly push electronic content and applications to the user's personal computer or other mobile electronic device capable of running such content or applications.

In information technology, a dashboard is a user interface that organizes and presents information in a way that is easy to read. In one embodiment of the present invention the dashboard may be used as a data capture tool. The dashboard is an effective means of collecting information about the consumer as well as relaying it to the marketer. In one embodiment, a user may be prompted to provide biographical information, social media, and/or contact information such as an e-mail address or telephone number. This information may then be forwarded to the marketer to facilitate data collection and analytics on the types of people consuming marketers products or engaging their services.

Once the requested information is provided, the consumer is presented with a variety of content downloaded or streamed to their electronic device. Such content may include, but is not limited to, social media, video, audio, text, and images. Because the content is capable of being streamed via the Internet, the marketer is afforded a larger degree of latitude in modifying and adding content compared to another embodiment where content is stored on an electronic device such as a USB key and downloaded onto the users computing device. Furthermore, such updates and modifications to content may be achieved instantaneously.

Embodiments of the invention will appear evident as the description proceeds. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### OBJECTS

It is therefore an object of the present invention to provide a method and apparatus for an advertiser to communicate directly with consumers while learning about them using a portable electronic device or web key.

A primary object of the present invention is to allow marketers to provide consumers and potential consumers with interactive and quickly updateable content. This object may be accomplished via an electronic device such as a personal computer. Other means to further this end include, but are not limited to, mobile electronic comp devices capable of loading platforms for marketers to communicate with consumers and potential consumers.

Another object is to provide a customizable dashboard to effectuate the marketing needs of the advertiser. Such a dashboard may be a portal to rich content and media facilitating the interaction between consumer and marketer by providing the former with content designed to further brand recognition.

An additional object is to allow the electronic dashboard engagement device to contain downloadable content that may be accessed by the consumer even without access to the Internet. By way of example and not limitation, live footage of a concert or other live event may be recorded and transferred to the electronic device for download by the consumer. The current state-of-the-art allows for this to be accomplished extremely quickly. In one instance, live footage of a concert was recorded and then transferred onto twenty-thousand of the electronic devices for concert goers to take with them. This was accomplished all in just eighteen minutes for all twenty-thousand copies.

It is a further object of the present invention to supply marketers with valuable data analytics allowing them to track product or service usage including, but not limited to, how much time users spend on the marketers dashboard, what links the consumer followed, and the users geographic location.

The marketer may then be presented with a visual display of the identity data provided by the consumer. The data may be presented to the marketer in a variety of ways. For example, the data may be present as analytics, statistical graphs based on single or multiple consumer data points, or live data being streamed concurrently as the consumer is accessing the marketer's custom dashboard.

The inventors envision a variety of useful applications in such markets as fashion, entertainment, sports, education, and other industries where it is useful for marketers to collect information on the habits of their consumers.

The present invention further allows for a wide variety of customization options specifically designed for the marketer and the particular consumer they wish to engage.

Finally, it is an object of the present invention to reduce the marketers carbon footprint by providing a more environmentally friendly alternative to common mass-marketing methods that waste copious amounts of paper disbursing print media.

These and other objects, features, and advantages of the present invention will become apparent in the following detailed description of the present embodiment thereof when read in conjunction with the accompanying drawings wherein the same reference numerals denote like or similar parts throughout the several views.

Although the description that follows contains many specificities, these should not be construed as limiting the scope of the embodiments but as merely providing illustrations of some of several embodiments. Thus the scope of the embodiments should be determined by the claims that are appended and their legal equivalents, rather than by the examples given. Those skilled in the art to which this invention pertains will be able to devise other forms thereof within the ambit of the appended claims.

### DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

### FIGURES

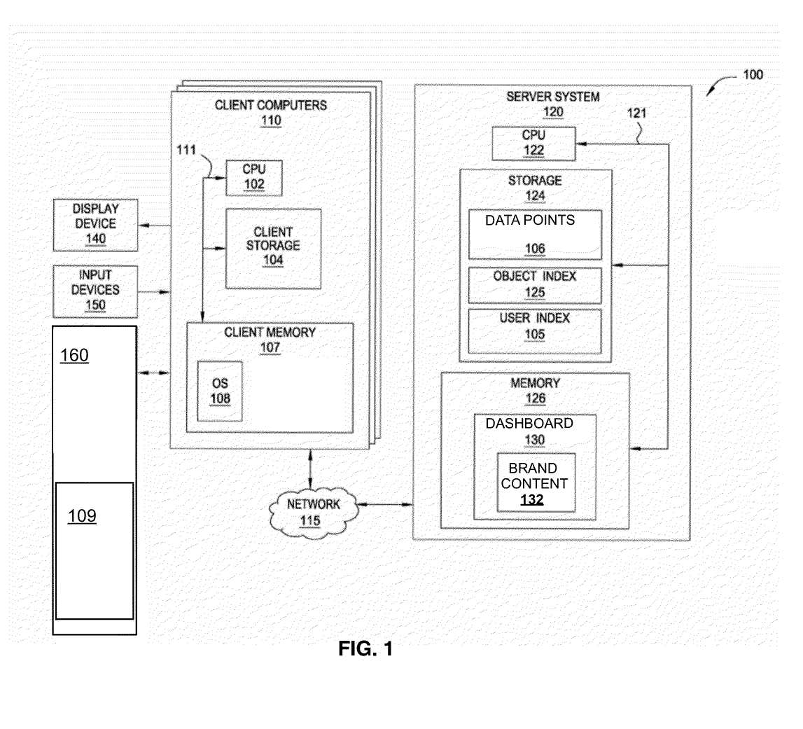

FIG. 1 is a block diagram that illustrates a client-server view of a computing environment configured for displaying marketer brand data and obtaining consumer identity data, according to one embodiment of the invention;

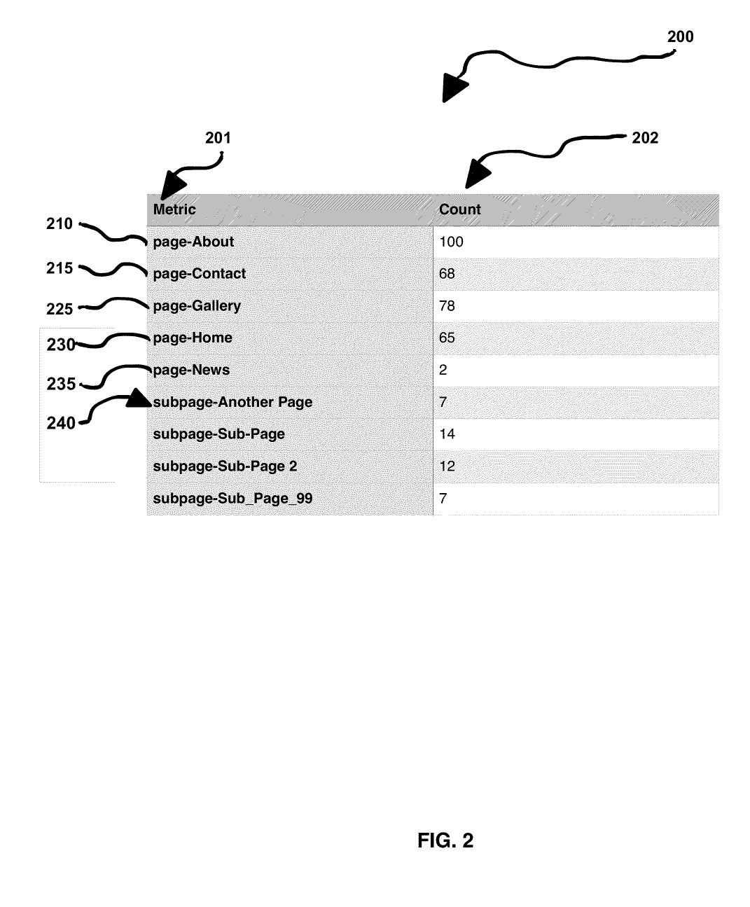

FIG. 2 illustrates a table which provides an example of a set of data points, according to one embodiment of the invention;

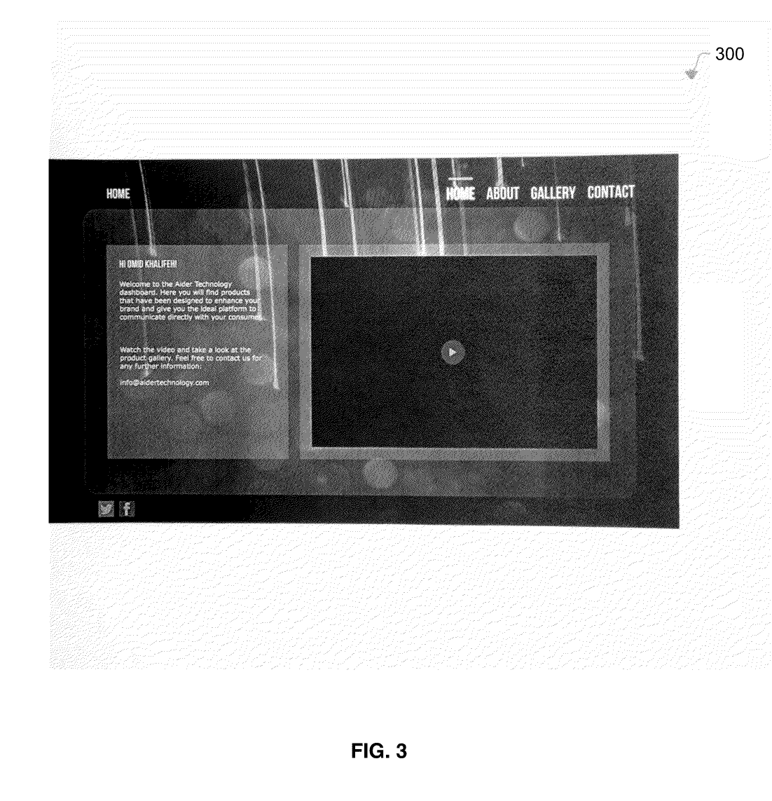

FIG. 3 illustrates an example dashboard presenting brand awareness content regarding a marketers brand such as different types of multimedia, text, and social media content, according to one embodiment of the invention;

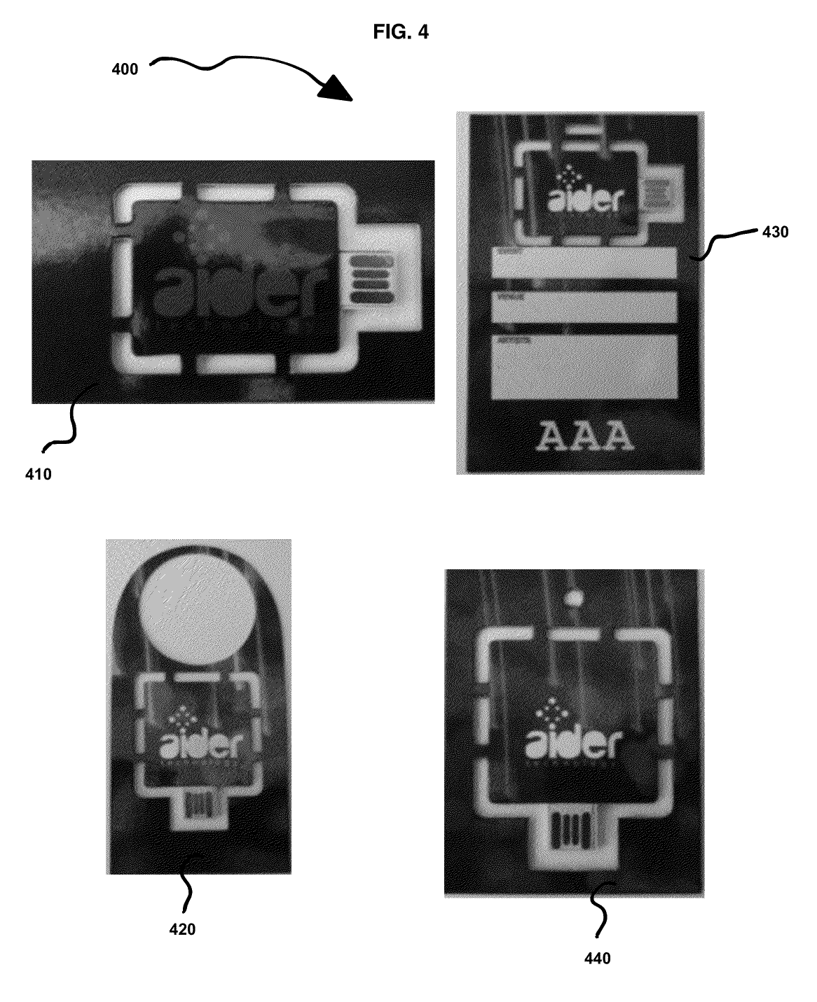

FIG. 4 illustrates a four examples of dashboard engagement keys in different forms, according to the present principles;

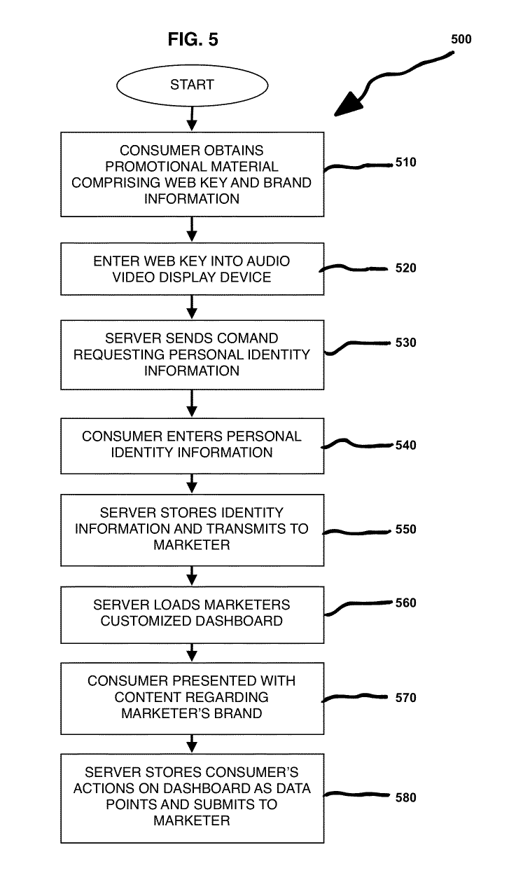

FIG. 5 is a block diagram of a non-limiting example system in accordance with present principles for a method and apparatus for facilitating consumer-marketer interaction using a Web key from the consumers perspective; and

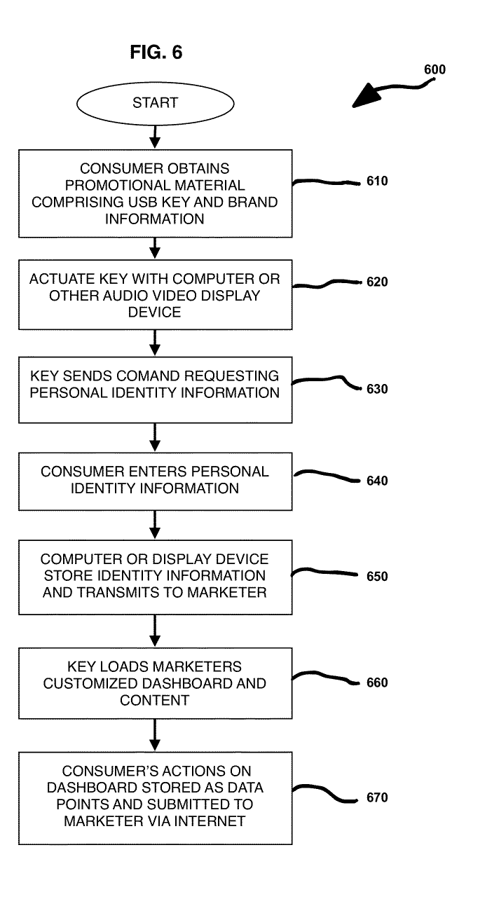

FIG. 6 is a block diagram of a non-limiting example system in accordance with present principles for a method and apparatus for facilitating consumer-marketer interaction using a USB key from the consumers perspective.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices, in addition, various programs described hereinafter may be identified based upon the application fir which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures tray be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, permanent or semi-permanent or only for an instant.

### DETAILED DESCRIPTION

Embodiments of the present invention provide techniques for allowing marketers to engage consumers and provide them with fresh content. The techniques create an incentive for users to take paper advertisements with them to their personal computers therefore increasing the amount of time they are imbued with the markets brand message. Because, in one embodiment, the content is provided to a computer via the Internet, the marketer is granted the flexibility of changing the content instantaneously. Accordingly, the brand message does not stagnate.

Furthermore, embodiments facilitate the transfer of information to the marketer about their patrons. The consumer may be prompted to answer a variety of questions in order to gain access to a custom dashboard prepared for the marketer. This information may then be organized and tabulated to provided marketers with analytical data about their consumers or potential consumers.

FIG. 1 is a block diagram that illustrates a client server view of a computing environment 100 configured tier displaying marketer brand content and obtaining consumer identity data, according to one embodiment of the invention. As shown, computing environment 100 includes client computers 110, network 115, and server system 120. In one embodiment, the computer systems illustrated in FIG. 1 are included to be representative of existing computer systems, e.g., desktop computers, server computers, laptop computers, tablet computers, and the like. The computing environment 100 illustrated in FIG. 1, however, is merely an example of one computing environment Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the sot ware applications illustrated in FIG. 1 and described herein may be implemented using computer software applications executing on existing computer systems, e.g., desktop computers, server computers, laptop computers, tablet computers, and the like. Ho the software applications described herein are not limited to any currently existing computing environment or programming language, and may be adapted to take advantage of new computing systems as they become available.

As shown, server system 120 includes a CPU 122, which obtains instructions and data via a bus 121 from memory 126 and storage 124. The processor 122 could be any processor adapted to support the methods of the invention. The memory 126 is any memory sufficiently large to hold the necessary programs and data structures. Memory 126 could be one or a combination of memory devices, including Random Access Memory, nonvolatile or backup memory, (e.g., programmable or Flash memories, read-only memories, etc.). In addition, memory 126 and storage 124 may be considered to include memory physically located elsewhere in a server 120, for example, on another computer coupled to the server 120 via bus 121. Server 120 may be operably connected to the network 115, which generally represents any kind of data communications network. Accordingly, the network 115 may represent both local and wide area networks, including the Internet.

Also as shown, memory 126 includes the marketer's dashboard 130. In one embodiment, marketer's dashboard 130 may be a software application that accepts connections from multiple clients. Illustratively, marketer's dashboard 130 includes brand-related content 132. Brand-related content 132 represent the content present within the marketer's dashboard 130 provided by marketer, including media content (such as music, videos, and pictures), text content (such as blogs and news articles), and social media content (such as Facebook® and Twitter® feeds) as elements controlled by a given user. Illustratively, storage 124 includes an object index 125, a user index 105, and identity information records 106. In one embodiment, the object index 125 may store data points pertaining to the amount of time a consumer spend viewing brand-related content 132 included in the dashboard 130, and may be accessed by the marketer in order to provide statistical analysis and reports.

Like server system 120, each consumer's computer 110 includes a CPU 102, bus 111, consumer's memory 107, and consumer's storage 104. CPU 102 is a programmable logic device that performs all the instruction, logic, and mathematical processing in a computer. consumer's storage 104 stores application programs and data for use by consumer's computer 110. Consumer's storage 104 includes hard-disk drives, flash memory devices, optical media and the like. Consumer's computer 110 is operably connected to the network 115.

Consumer's memory 107 stores elements of an operating system (OS) 108 and a marketer's application 109. Operating system 108 is the software used for managing the operation of the client computer 110. Examples of an operating system 108 include UNIX, a version of the Microsoft Windows® operating system, and distributions of the Linux® operating system.

In one embodiment, marketer's application 109 provides a software program that allows a user to connect to a marketer's dashboard 130, and once connected, to explore and interact with marketer's dashboard 130. Further, marketer's application 109 may be configured to generate and display a wide variety of content that the marketer desires to share with the user. The marketer application 109 may also be configured to generate and display the immersive environment to the user and to transmit the user's desired actions to marketer's dashboard 130 on server 120 and later used to prepare analytics for the marketer.

The user may view the marketer's dashboard 130 using a display device 140, such as an LCD or CRT monitor display, and interact with the market's application 109 using input devices 150 (e.g., a keyboard and a mouse). Further, in one embodiment, the user may interact with marketer's application 109 and marketer's dashboard 130 using a variety of dashboard engagement devices 160. For example, the consumer may use a device such as a universal serial bus (USB) key. Of course, embodiments of the invention are not limited to these examples and one of ordinary skill in the art will readily recognize that the invention may be adapted for use with a variety of devices configured to present actions of the user into actions performed by that user within marketer's dashboard 130.

FIG. 2 illustrates a table 200 which provides an example of a set of data points 106, according to one embodiment of the invention. As shown, the data points 106 in table 200 include a metric column 201 and a count column 202, page-About field 310 for consumer using the About page on the dashboard 130, a page-Contact field 215 for consumer using the Contact page on the dashboard 130, a page-Gallery field 225 for consumer using the Gallery page on the dashboard 130, a page-Home field 230 for Home, a page-News field 235 for News, and multiple subpage fields 235 for consumer usage of subpages. Of course, one of ordinary skill in the art will recognize that other metrics of data may be stored, such as time spent, items clicked, and the like.

FIG. 3 illustrates an example dashboard 300 presenting brand awareness content regarding a marketer's brand such as different types of multimedia, text, and social media content. The dashboard may be customized to cater to each individual marketer and the consumers they wish to engage. As illustrated, by way of example and not limitation, the dashboard may comprise links to pages such has an About page, providing content about the marketer, Gallery page, Contact page etc. Not shown, although still contemplated, are numerous subpages that the consumer can access through the dashboard and lead to, for example, blogs, links to external websites, news feeds, etc.

FIG. 4 illustrates a four examples of dashboard engagement keys 400 in different forms, according to the present principles. As shown, 410 illustrates a business card embodiment. 420 illustrates a hang tag for, by way of example, a door knob or bottle neck. 430 illustrates a swing tag embodiment and 440 an access all areas (AAA) embodiment. All are shown comprising dashboard engagement devices in this case USB keys. This is not meant to be limiting as Web key embodiment are also foreseeable to those of ordinary skill and are envisioned by the inventors. Likewise, the embodiment are branded, by way of example and not limitation, Aider Technology. This is not intended to be limiting as any number of brands may be used on the keys 400.

FIG. 5 is a block diagram of a non-limiting example system in accordance with present principles for a method and apparatus for facilitating consumer-marketer interaction using a Web key from the consumers perspective according to one embodiment of the invention. As shown, the method 500 begins at step 510, where consumer obtains promotional material comprising Web key and brand information as in FIG. 4 displaying the Aider Technology brand as an example. At step 520, the consumer enters the Web key information into customer's computer 110. At step 530, the server 120 sends a command to consumer's computer 110 requesting that the consumers enter their personal identity information. In one embodiment, this may be the consumer's e-mail address. Of course, embodiments of the invention are not limited to these examples and one of ordinary skill in the art will readily recognize that the invention may be adapted for use with a variety different types of personal information such as name, address, nationality, shopping preferences, and passwords.

In one embodiment, all identity information is stored on customer's computer 110 though in others the server 120 may also be used. Step 550 is illustrates the embodiment where the server 120 stores the identity and then transmits that information to the marketer.

At step 560, the consumer is granted access to the marketer's dashboard and it is uploaded onto consumer's computer. Step 570 is where the customer is presented with a variety of content related to the marketers brand. As discussed above, brand-related content 132 represents the content present within the marketer's dashboard provided by marketer, including media content, text content, and social media content as elements viewable by a given user. As shown at step 580, the server is storing information regarding the consumer's activity while logged into the marketer's dashboard. As discussed above, this may include the tabs they click on and the pages that they view as well as the amount of time they spend doing so. All of this information is stored as data points which may be transmitted to the marketer for data analysis that may be used to generate an analytics “dashboard” such as the example in FIG. 3.

FIG. 6 is a block diagram of a non-limiting example system in accordance with present principles for a method and apparatus for facilitating consumer-marketer interaction using a dashboard engagement device 160 from the consumers perspective according to one embodiment of the invention. As shown, the method 600 begins at step 610, where consumer obtains promotional material comprising USB key and brand information such as those illustrated by way of example ire FIG. 4.

For the purpose of illustration, the dashboard engaging device 160 is illustrated as a USB key. However, this is not intended to be limiting. One of ordinary skill in the art will readily recognize that the invention may be adapted for use with a variety different types of devices including, but not limited to secure digital (SD) card, thumb drives, and yet to be developed means of storing information on a pocket size device to be later retrieved by coupling that device with a computer or other capable audio video display device. At step 620, the consumer actuates the USB key 160 with customer's computer 110 or other audio video display device. As shown at step 630, the key 160 sends a command to consumer's computer 110 prompting a request that the consumer enter their person identity information.

In one embodiment, all identity information is stored on customer's computer 110 though in others the server 120 or USB key 160 may also be used. Step 650 is illustrates the embodiment where the customer's computer 110 stores the identity and then transmits that information to the marketer.

As shown at step 660, the consumer is granted access to the marketer's dashboard and it is uploaded onto consumer's computer 110. Step 670 is where the customer is presented with a variety of content related to the marketers brand. As discussed above, brand-related content 132 represents the content present within the marketer's dashboard 130 provided by marketer, including media content, text content, and social media content as elements viewable by a given user. The server may also store information regarding the consumer's activity while logged into the marketer's dashboard. As discussed above, this may include the tabs they click on and the pages that they view as well as the amount of time they spend doing so. All of this information is stored as data points which may be transmitted to the marketer for data analysis that may be used to generate an analytics “dashboard” such as the example in FIG. 3.

Although the invention has been described with reference to specific embodiments, it will be understood by hose skilled in the art that various changes may be made without departing from the scope of the invention. Accordingly, the disclosure of embodiments is intended to be illustrative of the scope of the invention and is not intended to be limiting. It is intended that the scope of the invention shalt be limited only to the extent required by the appended claims. To one of ordinary skill in the art, it will be readily apparent that the devices and method discussed herein may be implemented in variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents

### CONCLUSIONS, RAMIFICATIONS, AND SCOPE

While a particular form of the invention has been illustrated and described, it will be apparent that various modifications can be made without departing from the spirit and scope of the invention. For example, the incentive item or web key may be illustrated as a is illustrated in business cards, hang tags, and Access All Areas pass embodiments even though the inventor contemplates the possibility that the apparatus may be modified to suit a variety of different ways all the while comprising the properties of the invention. Accordingly, is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the method and apparatus for facilitating consumer-marketer interaction with which that terminology is associated. In general, the terms used in the following claims should not be constructed to limit the method and apparatus for facilitating consumer-marketer interaction to the specific embodiments disclosed in the specification, unless the above description section explicitly define such terms. Accordingly, the actual scope encompasses not only the disclosed embodiments, but also all equivalent ways of practicing or implementing the disclosed method and apparatus. The above description of embodiments of the method and apparatus for facilitating consumer-marketer interaction is not intended to be exhaustive or limited to the precise form disclosed above or to a particular field of usage. While specific embodiments of, and examples for, the method and apparatus are described above for illustrative purposes, various equivalent modifications are possible which those skilled in the relevant art will recognize.

While certain aspects of the method and apparatus for facilitating consumer-marketer interaction are presented below in particular claim forms, the inventors contemplate the various aspects of the method and apparatus in any number of claim forms. Accordingly, the inventor reserves the right to add additional claims after filing the application to pursue such additional claim forms for other aspects of the method and apparatus for facilitating consumer-marketer interaction.

What is claimed is:

1. An interactive method and apparatus for facilitating consumer-marketer interaction, comprising:
an audio video display device comprising a video display;
a Web key adorned with brand information for at least one marketer;
a server communicating with said audio video display device, wherein responsive to actuation of said Web key said server sends a command to said display device to request personal identity information associated with a consumer, said personal identity information comprising for each consumer, a plurality of personal identity information elements;
wherein said personal identity information elements are stored on said server and transmitted to said marketer;
a customizable dashboard comprising brand related content for enabling said marketer to communicate said content to said consumer wherein upon entry of said personal identity information said server sends a second command to said display device to load said dashboard;
wherein said consumer can navigate said dashboard while said consumer's actions are stored as a series of data points, stored on said server, and transmitted to said marketer.

2. The method and apparatus of claim 1 wherein said Web key further comprises a universal serial bus (USB) key.

3. The method and apparatus of claim 1 further comprising a first personal identity information element wherein said first personal identity information element is said consumer's e-mail address.

4. The method and apparatus of claim 3 further comprising a second personal identity information element wherein said second personal identity information element is said consumer's home address.

5. The method and apparatus of claim 3 further comprising a second personal identity information element wherein said second personal identity information element is said consumer's desired password.

6. The method and apparatus of claim 1 wherein said content comprises multimedia content.

7. The method and apparatus of claim 1 wherein said content comprises social media content.

8. The method and apparatus of claim 7 wherein said content is said marketer's Facebook® page.

9. The method and apparatus of claim 6 wherein said content further comprises links to external websites.

10. The method and apparatus of claim 9 wherein said content further comprises a news feed comprising brand related content.

11. The method and apparatus of claim 10 wherein said content further comprises a blog comprising brand related content.

12. An interactive method and apparatus for facilitating consumer-marketer interaction, comprising:
an audio video display device comprising a video display;
a universal serial bus (USB) memory key adorned with brand information for at least one marketer wherein said key is preloaded with content pertaining to said brand information;
wherein responsive to actuation of said Web key coupled to said audio video display device said key sends a command to said display device to request personal identity information associated with a consumer, said personal identity information comprising for each consumer, a plurality of personal identity information elements;
wherein said personal identity information elements are stored on said device and transmitted to said marketer;
a customizable dashboard comprising brand related content for enabling said marketer to communicate said content to said consumer wherein upon entry of said personal identity information said key sends a second command to said display device to load said dashboard;
wherein said consumer can navigate said dashboard while said consumer's actions are stored as a series of data points, stored on said device, and transmitted to said marketer.

13. The method and apparatus of claim 12 further comprising a first personal identity information element wherein said first personal identity information element is said consumer's e-mail address.

14. The method and apparatus of claim 13 further comprising a second personal identity information element wherein said second personal identity information element is said consumer's home address.

15. The method and apparatus of claim 13 further comprising a second personal identity information element wherein said second personal identity information element is said consumer's desired password.

16. The method and apparatus of claim 12 wherein said content is multimedia content.

17. The method and apparatus of claim 12 wherein said content is social media content.

18. The method and apparatus of claim 17 wherein said content is said marketer's Facebook® page.
